(19) United States
(12) Patent Application Publication
(10) Pub. No.: US 2005/0154779 A1
(43) Pub. Date: Jul. 14, 2005

(54) Apparatus and method for using data filters to deliver personalized data from a shared document

(76) Inventors: Raymond Cypher, Sherwood Park (CA); Trevor Daw, Vancouver (CA)

Correspondence Address: COOLEY GODWARD, LLP, 3000 EL CAMINO REAL, 5 PALO ALTO SQUARE, PALO ALTO, CA, 94306, US

(21) Appl. No.: 11/016,335

(22) Filed: Dec. 17, 2004

Related U.S. Application Data
(60) Provisional application No. 60/531,509, filed on Dec. 19, 2003.

(51) Int. Cl. G06F 15/16; G06F 17/21

(52) U.S. Cl. 709/202; 715/517

(57) ABSTRACT

A computer readable medium includes executable instructions to deliver data. The executable instructions include a master agent to process requests for access to a single document associated with the master agent. The single document includes document data and a document template. A user agent associated with an end user requests information from the single document. The user agent includes filtering criteria specifying information within the single document that the end user can view. The user agent interacts with the master agent to produce document output corresponding to selected document data within the single document without producing a new instance of the single document.

### CROSS-REFERENCE TO RELATED APPLICATIONS

This application claims priority to the U.S. provisional patent application entitled, “Apparatus and Method for Document Data Sharing through the use of Data Filters”, Ser. No. 60/531,509, filed Dec. 19, 2003.

### BRIEF DESCRIPTION OF THE INVENTION

This invention relates generally to the processing of documents in a business intelligence system. More particularly, this invention relates to a technique for using data filters to deliver personalized data from a shared document.

### BACKGROUND OF THE INVENTION

Business intelligence generally refers to software tools used to improve business enterprise decision-making. These tools are commonly applied to financial, human resource, marketing, sales, customer and supplier analyses. More specifically, these tools can include: reporting and analysis tools to present information; content delivery infrastructure systems for delivery and management of reports and analytics; data warehousing systems for cleansing and consolidating information from disparate sources; and, data management systems, such as relational databases or On Line Analytic Processing (OLAP) systems used to collect, store, and manage raw data.

Business intelligence document delivery systems have been designed to share and deliver documents for several years, and in that time, these systems have increasingly evolved to include more capabilities for optimization of performance and scalability. In many document delivery systems, the delivery system comprises specific intelligence to detect when multiple users request the same document, and as a result, manages the process of refreshing the document and delivering it to those multiple users in an efficient way. In these cases, the systems refresh the document—that is, execute the report query against the data source(s)—to get the latest snapshot of data. These systems can further manipulate the data by re-organizing it, applying algorithms to it to transform some values, or generate new values—e.g. sums or percentages. Finally, formatting is applied to the results set.

For efficiency, this is done just once, even if several users request the refresh. The system is intelligent enough to deliver a copy of this one result to each of the users requesting it—without the need to regenerate either the data (having to access the data source in-so-doing) or the formatted report. Such efficiencies conserve database processing, disk space, memory and management processing time that would otherwise be involved with maintaining many copies of the same report object. Note that the results set can be a combination of data from single or multiple queries against either a single data system or multiple heterogeneous data systems, including relational, OLAP, and the like.

However, until now, if different users requested or needed different versions of the same document, either because their data viewing privileges were different or because they had a need to filter the document such that only a subset of the data was shown, the document delivery system would treat these instantiations of the same document as different documents and generate a different version of the data for each. Thus, a new instance of the document is created each time a version of the document or some information within the document is accessed. This sort of duplication increases processing, memory and disk overhead that negatively impacts system performance and scalability.

Commercial database management systems have employed sophisticated data caching and sharing strategies. However, these strategies should not be confused with those related to business intelligence system document delivery because they tend to be more granular in focus. They manage the caching/sharing strategy at the lowest level of granularity at which the database management system query engine manipulates and stores data (i.e., at the data page or block level, depending on the implementation).

In other words, these systems tend not to deal with caching and sharing algorithms at the document level, but at a level of data organization that could comprise all or part of a result set that is sharable across many queries. When one of these granular entities is re-used from a cache, filtering can be applied, but the results are then consolidated into composite query data results that would be the set of data with which the business intelligence system starts. Document data sharing, in contrast, applies to a combination of data from single or multiple queries against either a single data system or multiple heterogeneous data systems. Document data sharing also includes filtering formula and aggregate data contained within the document itself.

Other solutions allow multiple users to view the same document with different filtering criteria. For example, instead of sharing the data from a single document, an entirely separate document instance can be generated for each user. Each of these instances has its own copy of the data filtered for that user. Creating separate instances is very expensive, and for many customer applications this approach may require scheduling the creation of large numbers of instances every day. For example, suppose a company needs to produce a report every day for each sales agent showing the accounts he/she is working on. If there are 500 sales agents in the company this means creating 500 document instances every day. This requires significant processing and storage.

Another prior art approach is called print job cloning, which is implemented when multiple users view the same report. In this case, a single master agent makes a copy of the subset of data that passes the user's filter. This is the same as creating a new document instance (template plus data) for each user.

One prior art solution filters pages of reports when viewing. With this feature, multiple users viewing a single report share a set of pages and have different permissions about which pages they can see. This means the pages each user sees are identical, just that some users may not be able to see certain pages. While some users may not be able to see certain pages, a security shortcoming associated with this technique results in situations where users have access to summary calculations associated with pages that should not be viewable. Another problem with this approach is that it results in large files being transferred to a user, thereby producing sub-optimal network traffic and end-user memory utilization.

It would be highly desirable to provide a system that overcomes the foregoing shortcomings associated with prior art techniques.

### SUMMARY OF THE INVENTION

The invention includes a computer readable medium with executable instructions to deliver data. The executable instructions include a master agent to process requests for access to a single document associated with the master agent. The single document includes document data and a document template. A user agent associated with an end user requests information from the single document. The user agent includes filtering criteria specifying information within the single document that the end user can view. The user agent interacts with the master agent to produce document output corresponding to selected document data within the single document without producing a new instance of the single document.

The invention also includes a computer readable medium with executable instructions to deliver data. The executable instructions define a set of user agents associated with a set of end users requesting information from a document. Each end user has a corresponding user agent specifying filter criteria. A master agent interacts with the user agents to access the document and to deliver to each end user personalized document output in accordance with user agent filter criteria for each end user. The master agent produces personalized document output without producing a new instance of the document.

The present invention allows data from a single business intelligence document to be shared by multiple users with different filtering criteria. The invention provides mechanisms that make it possible to have the data within the document filtered independently for each user without making a copy or subset of the document data. The invention allows multiple users to open the same report instance and filter the report data to see only the information they are interested in. This is done without making a copy of the report data for each user. This results in improved system performance and scalability.

### BRIEF DESCRIPTION OF THE FIGURES

The invention is more fully appreciated in connection with the following detailed description taken in conjunction with the accompanying drawings, in which:

FIG. 1 illustrates data filtering of a single document in accordance with various access filters utilized in accordance with an embodiment of the invention.

FIG. 2 illustrates data filtering of a single document in accordance with various preference filters utilized in accordance with an embodiment of the invention.

FIG. 3 illustrates basic processing operations associated with an embodiment of the invention.

FIG. 4 illustrates data view construction operations implemented in accordance with an embodiment of the invention.

FIG. 5 illustrates the processing of embedded documents in accordance with an embodiment of the invention.

FIG. 6 illustrates embedded document processing in accordance with an embodiment of the invention.

FIG. 7 illustrates embedded document processing in accordance with an embodiment of the invention.

FIG. 8 illustrates a computer implemented in accordance with an embodiment of the invention.

Like reference numerals refer to corresponding parts throughout the several views of the drawings.

### DETAILED DESCRIPTION OF THE INVENTION

The invention is described in connection with the following definitions.

Document refers to a file or organization of structured information that is comprised of document data and a document template. The document could be a report, spreadsheet, workbook, etc. A document is an organization of structured information that comprises a snapshot of data and a processing template. A snapshot of data may be generated by a data query that may or may not have been created through a semantic layer. The data query may access one or many data sources (relational, OLAP, or other). The user may enter a snapshot of data in whole or part. A processing template may include formulas, sorts, grouping, and aggregation functions like sums, counts, and averages. A processing template may also include formatting information that specifies how the data should be formatted and presented to the user.

Document data is a snapshot of data that needs to be processed or laid out according to the document template to produce document output. The document data may be a snapshot of data generated by a data query against one or many data sources (relational, OLAP, other). The user may also enter the document data in whole or in part. The document data consists of an ordered collection of 1 to n discrete data elements.

A Document template is a processing template that describes how the document data should be processed to produce document output. The processing specified by the document template may include data manipulation operations like formulas, sorts, grouping, and aggregation functions like sums, counts, and averages. The document template may also specify formatting information that describes how to format and lay out the data elements for viewing, printing, or further processing.

Data Elements: Document data consists of an ordered collection of 1 to n discrete data elements. These data elements may be records, cells, rows, lists, or other sets of values.

Document Output refers to the output produced when the document data is processed according to the document template. Depending on what the template specifies, this output may be a collection of data elements or may be formatted content suitable for viewing or printing.

A Master Agent is the unique agent created for a document when it is first requested. The master agent opens the document and handles requests from all user agents for access to the document template and document data.

User Agent is the specific agent created for a user requesting a document. There is one user agent for each unique user requesting the document. The user agent stores the filtering criteria and data view for that user. All user agents for a document access the document template and the document data through the single master agent.

Filtering criteria is the criteria defining how the document data should be filtered for a specific user. The filtering criteria are stored in the user agent. The document delivery system may provide the filtering criteria to the user agent in order to enforce security on the document data. The user may also specify additional filtering criteria to the user agent.

A Data View is the map constructed dynamically by the user agent from the filtering criteria and the document data. The map associates the index number of each data element in the document data with a value of true or false indicating whether or not the data element passes the filtering criteria. After the filter map is created, sorting criteria is applied to specify the order in which data is accessed. Thus, the data view has associated filtering and sorting criteria.

A Document Delivery System is a managed environment for delivery of documents to multiple users across an organization. The system may or may not include security management. The system typically has a facility to publish documents to a central infrastructure repository. Users can access this central repository, view the lists of the documents available, and select a document to view. The most recent implementations of such systems are web based, meaning that the means of accessing document lists and viewing the documents themselves is via a web browser.

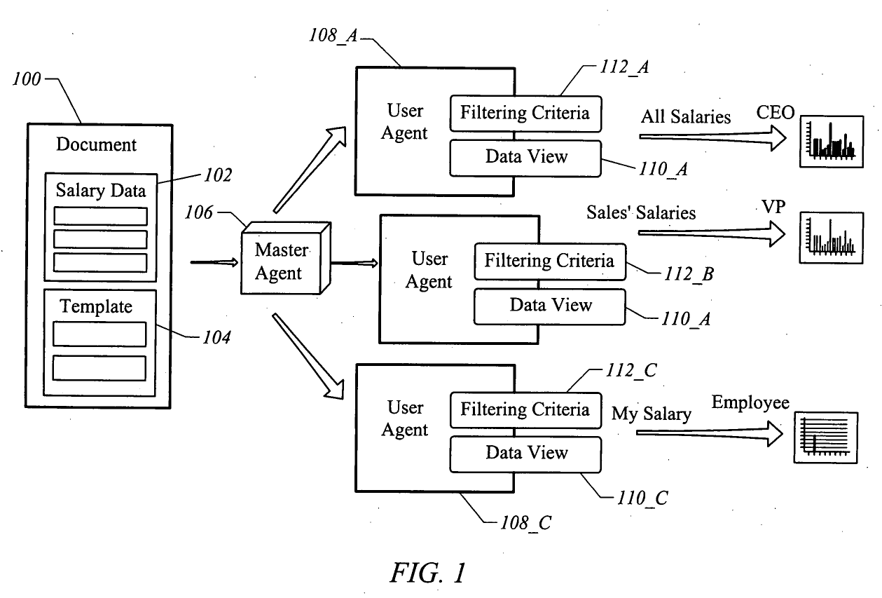

FIG. 1 illustrates the foregoing concepts and definitions. A document 100 has associated data (salary data in this example) 102 and a template 104. FIG. 1 also illustrates an associated master agent 106. User agents 108_A through 108_C access the master agent 106. Each user agent 108 has an associated data view 110 and filtering criteria 112. In this example, users have different access rights to data elements. The document 100 contains salary information for an entire company. Each user is allowed to see the salaries of their direct reports only. When viewing the document, the data needs to be filtered for each user on this basis. In this situation, there is a single master agent 106 that is accessed by each of the user agents 108_A through 108_C. Based on the security permissions associated with the user (and any addition filtering the user requests), the user agents provide the appropriate personalized output. Thus, as shown in FIG. 1, the CEO has complete data, the vice president (VP) has a reduced set of data and the employee only sees data associated with his or her own salary.

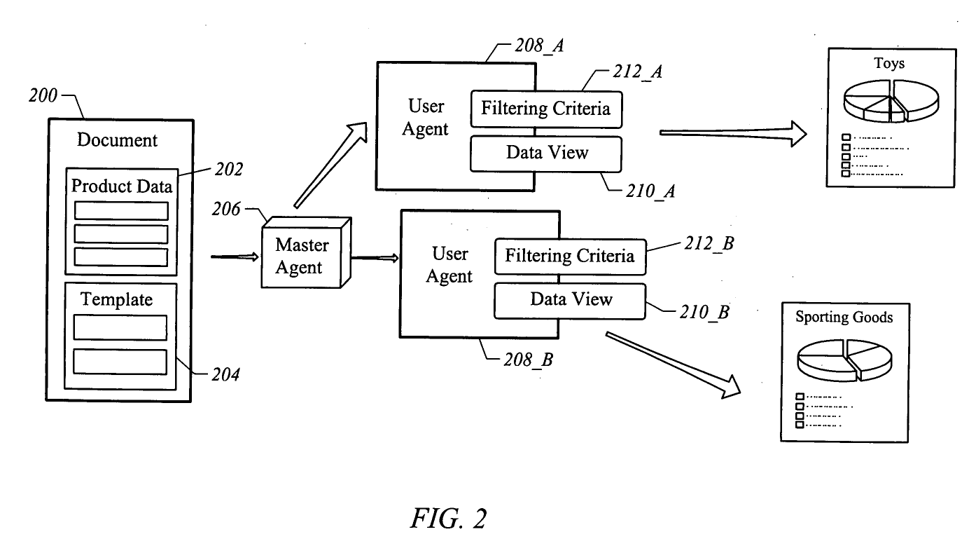

FIG. 1 provides an example of institutional access control filtering. The invention may also be used in accordance with personal data preferences, as shown in FIG. 2. When viewing a document, users may wish to filter the data in order to show the information that is of most interest to them. For example, document 200 contains sales data for all sales regions. The document has an associated master agent 206. Each user wants to filter the document to see only the regions they work in. The user may specify which regions to filter by modifying the filter criteria interactively or by changing parameter values in the report. In this situation, there is a single master agent 206 that is accessed by each of the user agents 208_A and 208_B. Based on the preferences indicated in the filtering criteria 212, the user agents provide the appropriate document output that reflects the user preferences (filtering criteria).

Observe in FIGS. 1 and 2 that personalized document output is produced for end users, but a new instance of the document (e.g., document 100 or document 200) is not produced. Instead, the personalized document output is the result of the filtering criteria for each user. This streamed personalized document output may be saved at the client side after delivery, but is not saved as a new document instance on the server side. Thus, the invention reduces server side data handling and memory requirements.

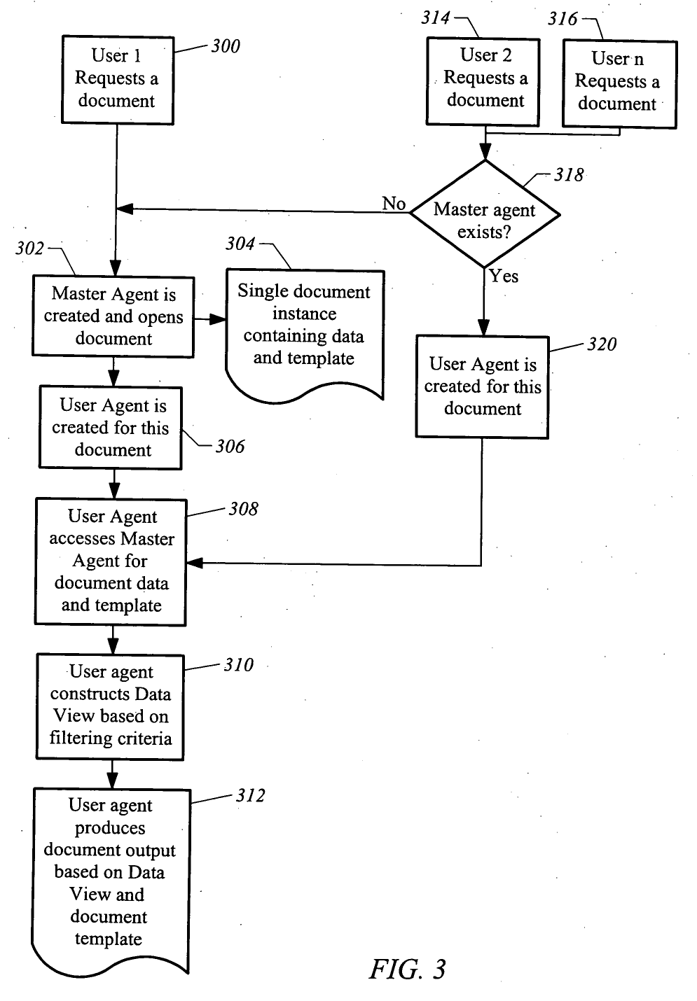

FIG. 3 illustrates processing operations associated with an embodiment of the invention. A first user (e.g., a first user at a first client machine) requests a document 300 (e.g., a document resident on a server). This results in the creation of a master agent 302. As discussed above, the master agent is associated with a single document instance with document data and a template 304.

A user agent is then created for this document 306. The user agent then accesses the master agent for document data and a template 308. The user agent then constructs a data view based on filtering criteria 310. The user agent also produces document output based on the data view and the document template 312.

FIG. 3 further illustrates that if additional users (e.g., at different client machines) request the same document (e.g., the same document on the same server), additional instances of the document are not created. Instead, if additional users, such as a second user requests the document 314 or an Nth user requests the document 316, a decision is made to determine whether a master agent exists 318. If so, another user agent is created 320. Thus, a user agent exists for each user. If not, then the previously discussed operations 302-312 are invoked.

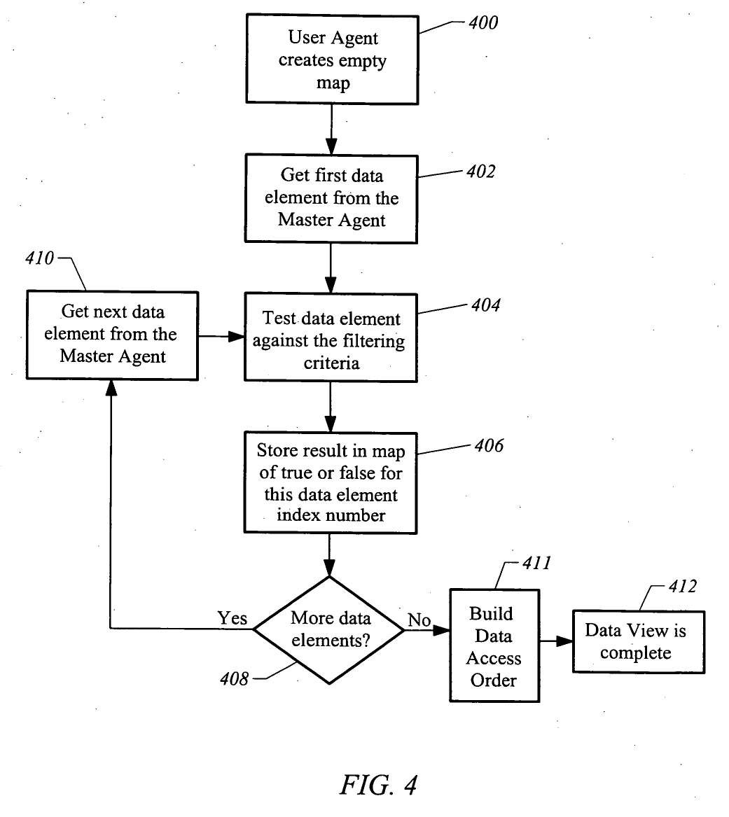

Operation 310 of FIG. 3 is more fully characterized in FIG. 4. That is, FIG. 4 provides a more complete characterization of the operation of a user agent constructing a data view based on filtering criteria. Initially, a user agent creates an empty map 400. A first data element is then retrieved from the master agent 402. The data element is tested against the filtering criteria 404. A first value (e.g., true) or second value (e.g., false) result for this data element is then stored at an associated index number 406. If there are more data elements 408, then the next data element is retrieved from the master agent 410. This process is repeated until there are no more data elements, at which point the ordering for the data access is built 411, and the data view is complete 412.

The final operation 312 of FIG. 3 is more fully appreciated with the following additional information. As previously indicated, the user agent produces document output based on the data view and the document template. In particular, the user agent accesses its data view to find out which data elements pass the filtering criteria. The user agent requests data elements that pass the data view as needed from the master agent. The data elements to be requested may depend on the processing specified by the document template and also on which page or part of the document the user has requested. The user agent accesses the document template from the master agent. Based on the template, the user agent may or may not calculate formulae, sorts, groupings, and aggregation functions like sums, counts, and averages. The user agent accesses the document template from the master agent, and based on the template, may or may not format and lay out the data elements in the document output.

As should be appreciated from FIG. 3, there may be multiple user agents simultaneously applying filtering criteria, building data views, and producing document output. The filtering criteria in one of the user agents may be modified at any point in the process in response to a request by the user or by the document delivery system. In this case, the affected user agent creates a new data view for the new filtering criteria. This does not impact the master agent and the other user agents.

A user agent can make changes to the document template or the document data in the following manner. The user agent initially requests a new master agent for the document from the document delivery system. The new master agent opens a new copy of the document. The user agent then disconnects from the original master agent and connects to the new master agent. The user agent then applies changes to the copy of the document in the new master agent. A new data view with the specified filtering and sorting criteria is then applied against the modified document. The other user agents continue to use the original master agent and are not impacted by this operation.

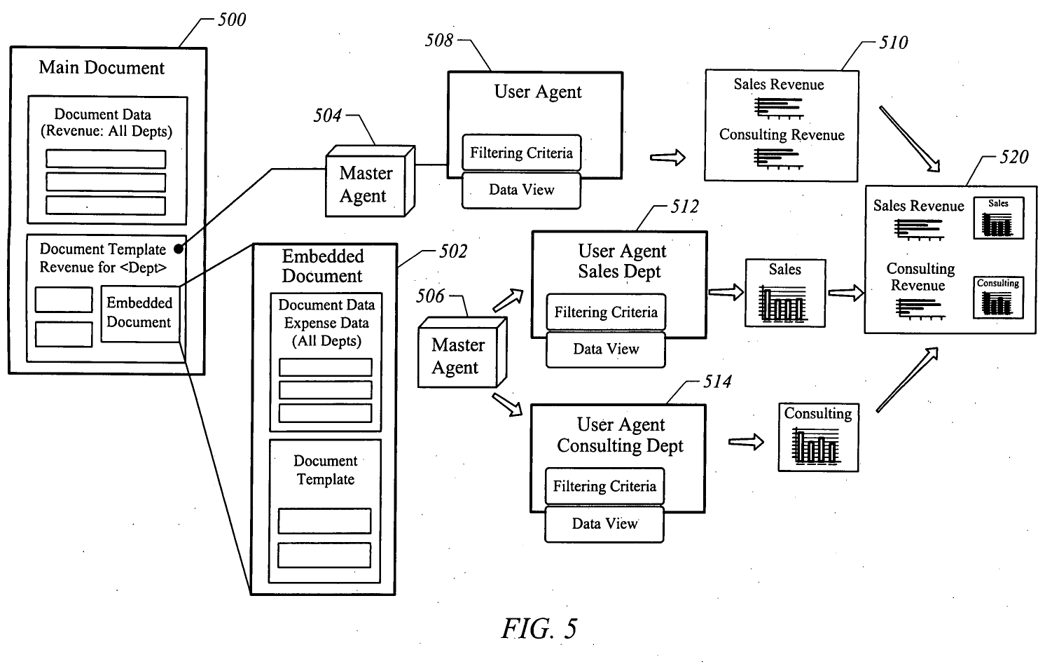

FIG. 5 illustrates that a document 500 may contain an embedded document 502. Each document 500 and 502 includes document data and a document template. In addition, each document has an associated master agent, 504 and 506 in this case. An embedded document may result in the processing of the document multiple times with different filtering criteria. For example, as shown in FIG. 5, master agent 504 and user agent 508 produce a document showing sales revenue and consulting revenue. The document also contains an embedded document 502 with expense data for each department. The user agents 512 and 514 access the document 502 through the master agent 506. The document filters of the user agents 512 and 514 produce expense data for the sales and consulting departments, respectively. So, for example, if there are five departments, there will be five instances of the embedded document, each with its own filtering criteria.

The conventional approach to this problem is to process each embedded document instance separately. This means running a separate data query for each instance, which is quite inefficient. Data will also be duplicated if the filters for instances overlap.

The document data sharing of the invention provides a much more scalable solution to this problem. A single embedded document is created containing the template and composite document data required for all instances of the embedded document. Multiple user agents access the composite document data through a single master agent for the embedded document. Each user agent constructs a data view based on its filtering and sorting criteria and produces output for an embedded document instance. The output is then incorporated into the document output of the main document.

There can be any number of embedded document instances sharing a single embedded document master agent. In this example, there could be more departments in the company. Each new department requires a separate user agent that accesses the single master agent.

There can also be any number of other separate embedded documents within the main document. For example, in FIG. 5 document 520 shows revenue and expenses for departments. There could be another embedded document for human resources to show the number of personnel/growth in each department. The human resources embedded document would be separate from the embedded document for expenses and would have its own master agent for the human resources embedded document. The user agent for the main document would process the human resources embedded document separately. This human resources document would then have specific instances for each department in the company.

Embedded documents may also contain other embedded documents, creating a hierarchy of embedded documents inside the main document. The document data sharing of the invention can be used to share and filter a single copy of the data for the instances of each embedded document in the hierarchy. The scalability and performance provided by the invention is significant since documents may contain thousands of embedded document instances.

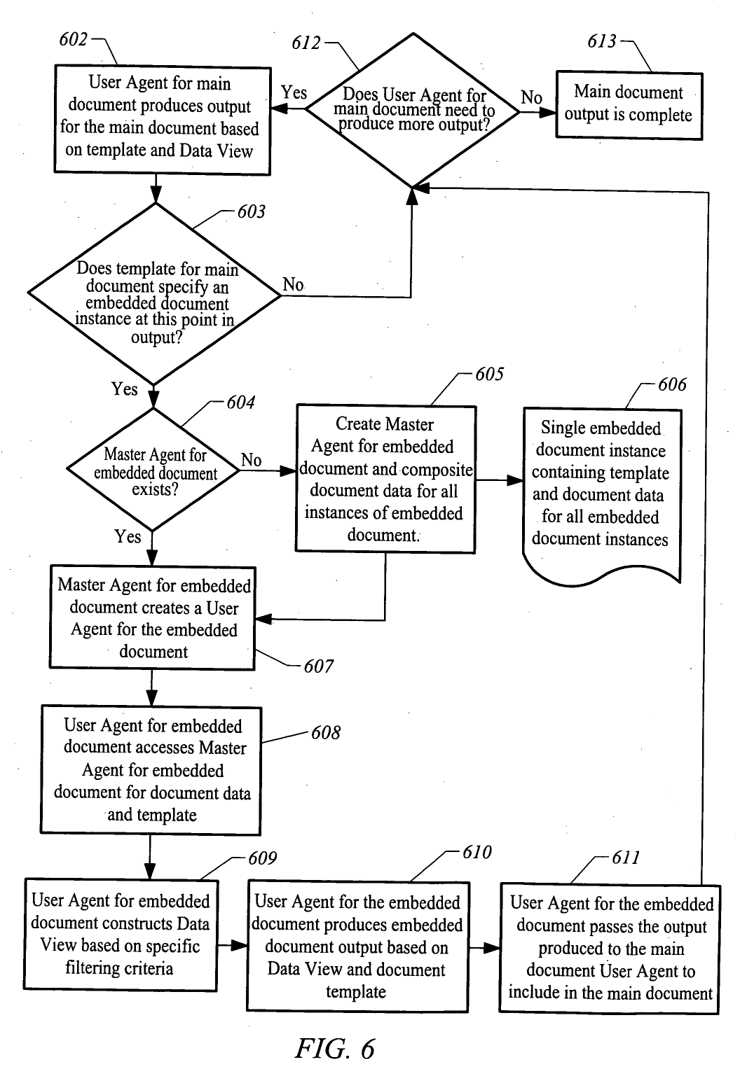

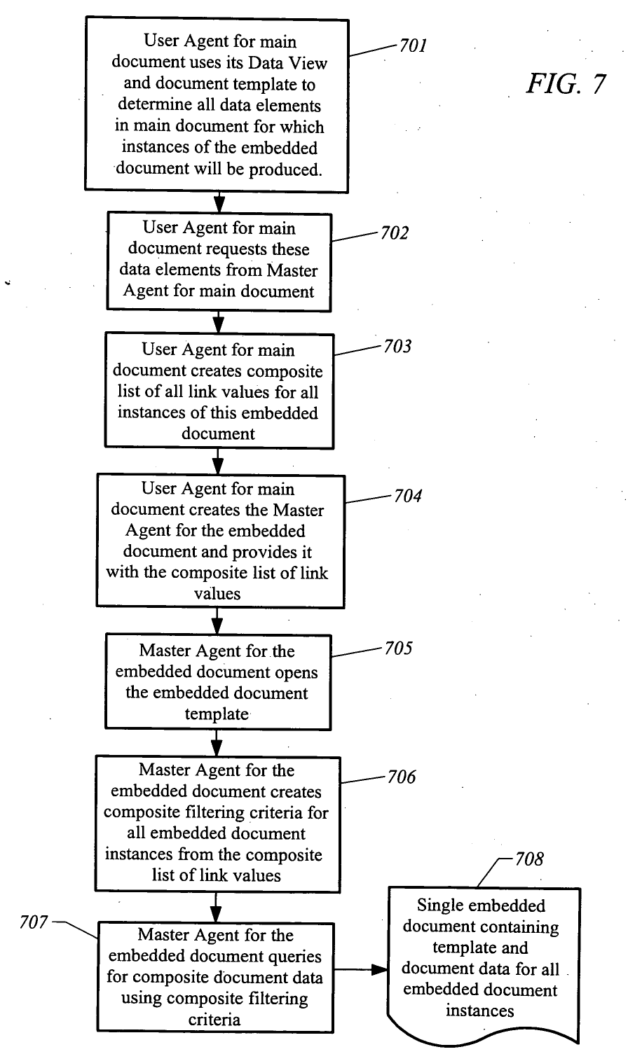

The processing of embedded documents is more fully appreciated in reference to FIG. 6. The first operation of FIG. 6 is for a user agent for the main document to produce output for the main document based on a template and a data view 602. A determination is then made whether the template for the main document specifies an embedded document instance. As previously indicated, the template for the main document specifies how to place the embedded document in the main document output. If the template for the main document indicates that there is an embedded document at this point in the output, then it is determined whether a master agent exists for the embedded document 604. This check is necessary to avoid creating duplicate master agents. If the master agent does not exist, a master agent is created for the embedded document and composite document data for all instances of the embedded document 605. This results in a single embedded document instance containing template and document data for all embedded document instances 606. The creation of a master agent is further discussed below in connection with FIG. 7.

Once a master agent is created, the master agent creates a user agent for the embedded document 607. If there are multiple instances of an embedded document, there will be a user agent for each of these instances that share the same master agent. The user agent for an embedded document then accesses the master agent for the document data and template for the embedded document 608. The user agent for an embedded document then constructs a data view based on specific filtering criteria 609. The user agent for the embedded document then produces embedded document output based on the specified data view and document template 610. In other words, the user agent for the embedded document creates the final output that is specific to the instance of the embedded document specified at this point in the main document. Finally, the user agent for the embedded document passes the produced output to the main document user agent to include in the main document 611. At this point, the main document is able to output the embedded document content.

A check is then made to assess whether the user agent for the main document needs to produce more output. In particular, the user agent for the main document references its data view and template to determine whether it has completed producing the requested output or whether is needs to continue producing main document output (potentially including additional embedded document instances). If there is further output required, then processing returns to operation 602. Otherwise, the main document output is complete 613.

FIG. 7 more fully characterizes the operation of creating a master agent and composite data for all embedded document instances. Initially, a user agent for the main document uses its data view and document template to determine all data elements in the main document for which instances of the embedded document will be produced 701. For example, if the main document includes an embedded report instance for three departments, the user agent uses its data view to determine the three corresponding data elements.

The user agent for the main document then requests the data elements from the master agent for the main document 702. The user agent for the main document creates a composite list of all link values for all instances of the embedded document 703. The main document template defines link values that are used to pass contextual information to the embedded document. For example, an embedded document shown once per department uses the current department as a link value. The composite link values would include sales, consulting, and other departments.

The user agent for the main document then creates the master agent for the embedded document and provides it with the composite list of link values 704. The master agent for the embedded document then opens the embedded document template 705. The master agent for the embedded document then creates composite filtering criteria for all embedded document instances from the composite list of link values 706. The link values are combined with filtering criteria specified by the embedded document template to produce composite filtering criteria for all embedded document instances. The master agent for the embedded document then queries for composite document data using composite filtering criteria 707. Document data for all instances of the embedded document is returned from this query. If there is only a single data source, this may require only a single query against the underlying data store, which is a performance advantage. This processing results in a single embedded document containing the template and document data for all the embedded document instances 708.

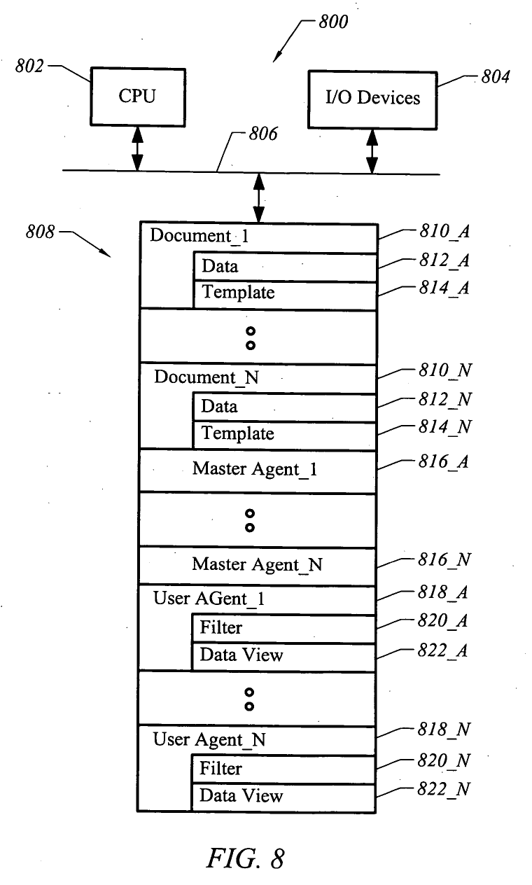

FIG. 8 illustrates a computer 800 implemented in accordance with an embodiment of the invention. The computer 800 includes a central processing unit 802 connected to a set of input/output devices 804 via a bus 806. The input/output devices 804 may include a keyboard, mouse, touch screen, printer, monitor, network connection and the like. Also connected to the bus 806 is a memory 808. The memory 808 stores a number of documents 810_A through 810_N. As previously discussed, each document includes data 812 and a template 814. The memory 808 also stores a set of master agents 816_A through 816_N. Each master agent includes executable instructions to implement the master agent functionality discussed herein. The memory 808 also stores a set of user agents 818_A through 818_N. As previously discussed, each user agent has an associated filter 820 and data view 822. Each user agent includes executable instructions to implement the user agent functionality described herein. The documents and executable programs of FIG. 8 are shown on a single computer for simplicity. However, it should be understood that these components may also be distributed in a client-server network architecture. Requests for data typically originate at a client machine in a client-server network. The requests may be serviced in accordance with the invention by utilizing the master and user agents on a server or in some other configuration. The functionality associated with the invention is significant; where that functionality is implemented is not significant.

An embodiment of the present invention relates to a computer storage product with a computer-readable medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as floptical disks; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1. A computer readable medium including executable instructions to deliver data, comprising:
a master agent to process requests for access to a single document associated with said master agent, said single document including document data and a document template; and
a user agent associated with an end user requesting information from said single document, said user agent including filtering criteria specifying information within said single document that said end user can view;
wherein said user agent interacts with said master agent to produce document output corresponding to selected document data within said single document without producing a new instance of said single document.

2. The computer readable medium of claim 1 wherein said filtering criteria include executable instructions to implement filtering criteria personalized for said end user.

3. The computer readable medium of claim 2 wherein said filtering criteria include executable instructions to implement filtering criteria personalized for said end user based upon institutional access control.

4. The computer readable medium of claim 2 wherein said filtering criteria include executable instructions to implement filtering criteria personalized for said end user based upon user data preferences.

5. The computer readable medium of claim 1 wherein said master agent includes executable instructions to process requests from a plurality of user agents corresponding to a plurality of end users.

6. The computer readable medium of claim 1 wherein said master agent includes executable instructions to produce said master agent in response to a request to access said single document.

7. The computer readable medium of claim 1 wherein said user agent includes executable instructions to interact with said master agent to access said document data and said document template.

8. The computer readable medium of claim 1 wherein said user agent includes executable instructions to construct a data view based on sorting criteria and said filtering criteria.

9. The computer readable medium of claim 8 wherein said data view is a dynamically constructed map with a plurality of indexed data elements.

10. The computer readable medium of claim 8 wherein said user agent includes executable instructions to:
test data elements from said master agent against said filtering criteria and produce a first value if said filtering criteria is met and produce a second value if said filtering criteria is not met; and
store first values and second values associated with data elements of said master document to produce a data view.

11. The computer readable medium of claim 1 wherein said single document includes an embedded document.

12. The computer readable medium of claim 1 further comprising a second master agent associated with said embedded document.

13. The computer readable medium of claim 12 further comprising a second user agent associated with said second master agent.

14. The computer readable medium of claim 13 further comprising executable instructions to create a single embedded document instance containing a template and document data for all embedded document instances.

15. A computer readable medium including executable instructions to deliver data, comprising:
a plurality of user agents associated with a plurality of end users requesting information from a document, each end user having a corresponding user agent specifying filter criteria; and
a master agent interacting with said plurality of user agents to access said document and to deliver to each end user personalized document output in accordance with user agent filter criteria for each end user, said master agent producing said personalized document output without producing a new instance of said document.

16. The computer readable medium of claim 15 wherein each user agent includes executable instructions to interact with said master agent to access document data and a document template associated with said document.

17. The computer readable medium of claim 15 wherein said user agent includes executable instructions to construct a data view based on said filtering criteria.

18. The computer readable medium of claim 17 wherein said data view is a dynamically constructed map with a plurality of indexed data elements.

19. The computer readable medium of claim 15 wherein said document includes an embedded document.

20. The computer readable medium of claim 19 further comprising a second master agent associated with said embedded document and a plurality of secondary user agents associated with said second master agent.
